(19) United States
(12) Patent Application Publication
(10) Pub. No.: US 2011/0167953 A1
(43) Pub. Date: Jul. 14, 2011

(54) AUTOMOBILE STEERING WHEEL

(75) Inventor: JA-SHIN JAN, TAIPEI HSIEN (TW)

(73) Assignee: TAKAMORI ENTERPRISE CO., LTD., Taipei Hsien (TW)

(21) Appl. No.: 12/687,415

(22) Filed: Jan. 14, 2010

(51) Int. Cl. B62D 1/04

(52) U.S. Cl. 74/552

(57) ABSTRACT

An automobile steering wheel includes an extension support, a plurality of support connecting portions and a detachable member, and a plurality of support connecting portions are formed at an external periphery of the extension support, and a connecting section is disposed separately at both ends of the support connecting portion, and an assembly positioning hole is formed at the center of the extension support, such that the two connecting sections at both ends of the detachable member and the two connecting sections at both ends of the support connecting portion are fixed to each other to provide a flexibly variable structure to meet user requirements while maintaining the safety of using the automobile steering wheel.

### BACKGROUND OF THE INVENTION

1. Field of the Invention

The present invention relates to an automobile steering wheel including an extension support, a support connecting portion and a detachable member, and the extension support and a plurality of support connecting portions are formed at an external periphery of the extension support, and a connecting section is disposed separately at both ends of the support connecting portion, and an assembly positioning hole is formed at the center of the extension support, such that the two connecting sections at both ends of the detachable member and the two connecting sections at both ends of the support connecting portion are fixed to each other to provide a flexibly variable structure to meet user requirements while maintaining the safety of using the automobile steering wheel. With the innovative design, the present invention enhances the utility and value of the product.

2. Description of the Related Art

Automobile is a commonly used transportation to most people, and various related parts installed inside an automobile are important components for moving and driving the automobile, and both practical use and aesthetic design are factors taken into consideration of choosing an automobile. In addition, an automobile steering wheel is an important part for controlling the travelling direction of the automobile, and it is an indispensable part of the automobile, and thus its practical use and convenience directly affect the safety of driving the automobile, and the automobile steering wheel is also a driver's most frequently touched and seen part in the automobile. With reference to FIG. 1 for a schematic structural view of a conventional automobile steering wheel 10, the automobile steering wheel 10 is comprises of an extension support 11, a circular frame 14, a plurality of support connecting portions 12 coupled between the extension support 11 and the circular frame 14, and an assembly positioning hole 13 formed at the center of the extension support 11, wherein the assembly positioning hole 13 is provided for installing the automobile steering wheel 10 onto a steering transmission link rod. Since it is necessary to take the strength and safety of the automobile steering wheel into consideration, the structure of the steering wheel is basically made of a metal material by an injection molding, such that the extension support 11 and the circular frame 14 are formed integrally.

Automobile is a personalized tool, and steering wheel closely relates to the driver's personal preference and using habits, but the structure of the conventional automobile steering wheel is made of a metal material and formed integrally by the injection molding process, so that the conventional automobile steering wheel is generally manufactured in the shape of a circular disk. To meet different user requirements, manufacturers may modify the automobile steering wheel into various different shapes, but a small quantity of such steering wheels is manufactured by an injection molding process. Such arrangement not only incurs a higher manufacturing cost to manufacturers, but also costs drivers to exchange the steering wheel. In view of the shortcomings of the prior art, the inventor of the present invention based on years of experience in the related industry to conduct extensive researches and experiments, and finally developed an automobile steering wheel in accordance with the present invention to overcome the aforementioned shortcomings of the prior art.

### SUMMARY OF THE INVENTION

It is a primary objective of the present invention to provide an automobile steering wheel comprising an extension support, a support connecting portion and a detachable member, wherein the extension support includes a plurality of support connecting portions are formed at an external periphery of the extension support, and a connecting section is disposed separately at both ends of the support connecting portion, and an assembly positioning hole is formed at the center of the extension support, such that the two connecting sections at both ends of the detachable member and the two connecting sections at both ends of the support connecting portion are fixed to each other to provide a flexibly variable structure to meet user requirements while maintaining the safety of using the automobile steering wheel. With the innovative design, the present invention enhances the utility and value of the product.

The advantages, objectives, and effects of the present invention will become apparent with the detailed description of a preferred embodiment with related drawings as follows.

With reference to FIG. 2 for an automobile steering wheel 20 in accordance with the present invention, the automobile steering wheel 20 comprises: an extension support 21, a plurality of support connecting portions 22 and a detachable member 24.

The extension support 21 is integrally formed and made of a metal material, and has a plurality of support connecting portions 22 disposed at an external periphery of the extension support 21, and a connecting section 23 is disposed separately at both ends of the support connecting portion 22, and an assembly positioning hole 26 is formed at the center of the extension support 21.

In at least one detachable member 24, a connecting section 25 is disposed separately at both ends of the detachable member 24.

The connecting sections 25 at both ends of the detachable member 24 and the connecting sections 23 at both ends of the support connecting portion 22 are fixed to each other to constitute an integral structure.

### BRIEF DESCRIPTION OF THE DRAWINGS

FIG. 1 is a schematic structural view of a conventional steering wheel;

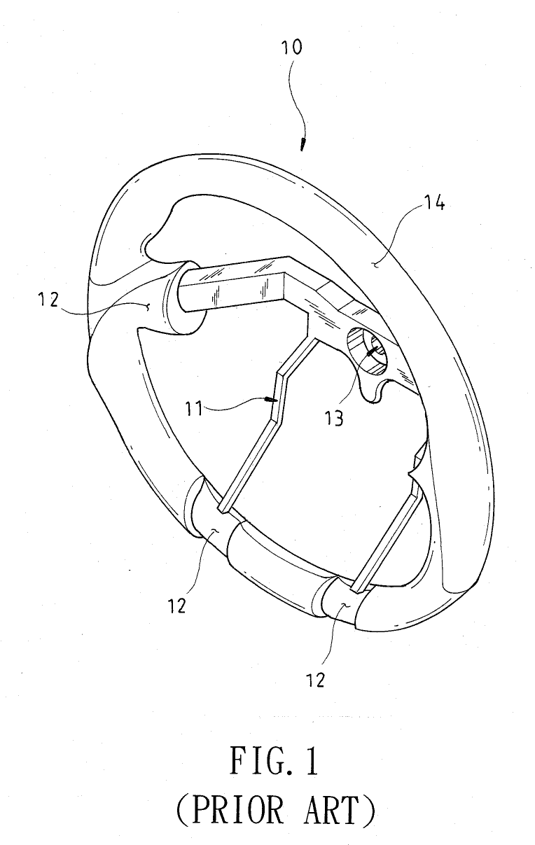

FIG. 2 is a schematic structural view of the present invention;

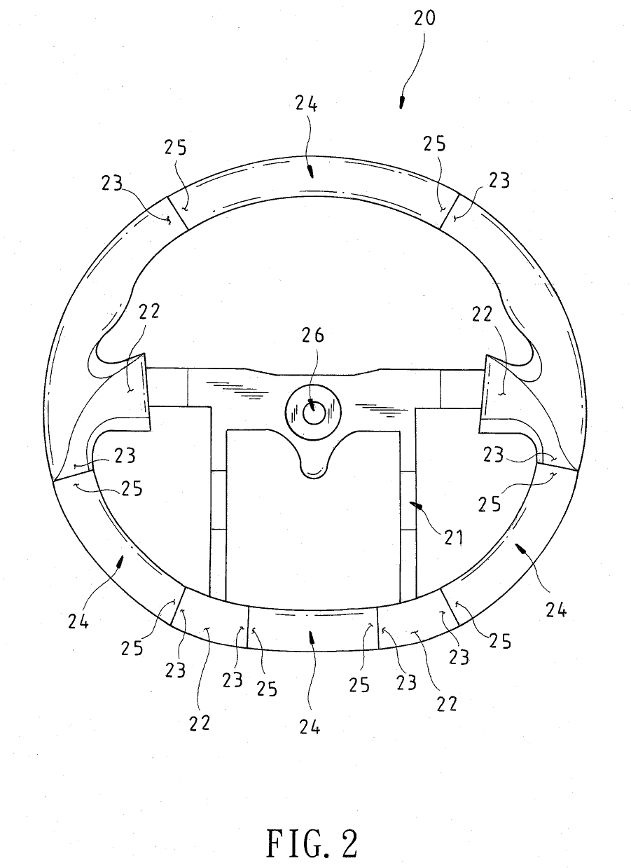

FIG. 3 is a perspective view of a preferred embodiment of the present invention;

FIG. 4 is an exploded view of a preferred embodiment of the present invention;

FIG. 5 is a schematic structural view of a detachable member 30 of the present invention;

FIG. 6 is a schematic structural view of a detachable member 40 of the present invention;

FIG. 7 is a schematic structural view of a detachable member 50 of the present invention;

FIG. 8 is a schematic structural view of a detachable member 60 of the present invention; and

FIG. 9 is a schematic structural view of a detachable member 70 of the present invention.

### DETAILED DESCRIPTION OF THE PREFERRED EMBODIMENTS

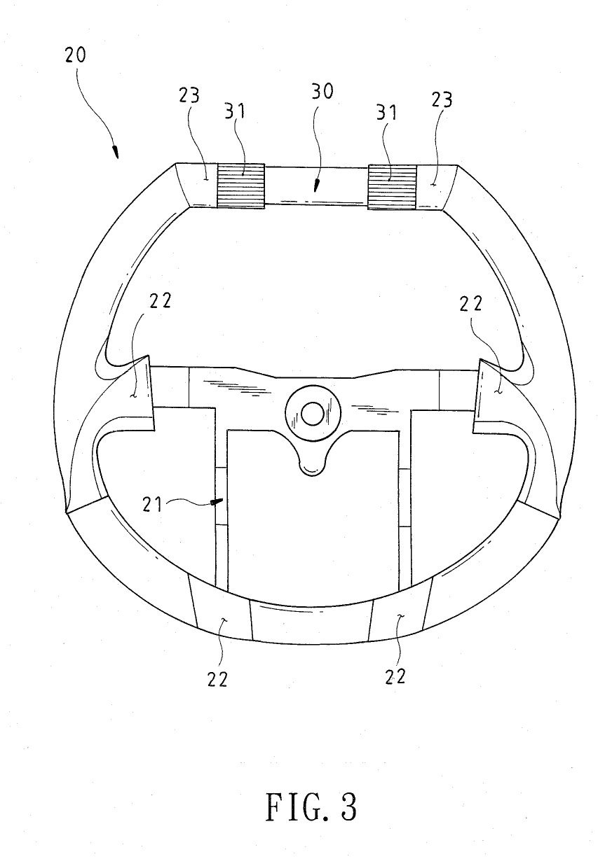

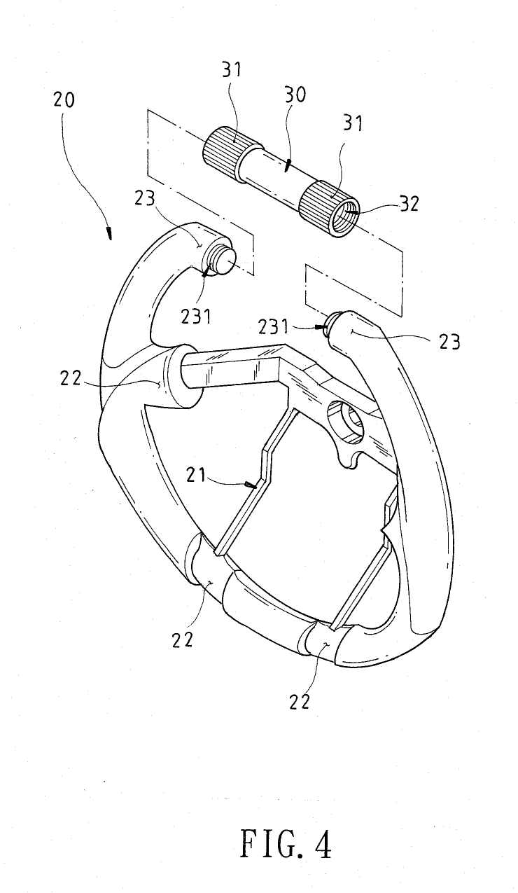

With reference to FIGS. 3 to 5 for an automobile steering wheel 20 of the present invention, the automobile steering wheel 20 comprises an extension support 21, a plurality of support connecting portions 22 disposed at an external periphery of the extension support 21, a connecting section 23 disposed separately at both ends of the support connecting portion 22, and an external thread 231 protruded from the connecting section 23. The detachable member 30 is a circular rod substantially in a straight form, and the detachable member 30 includes a connecting section 31 disposed separately at both ends of the connecting section 31, and an internal thread 32 formed at an internal periphery of the connecting section 31, such that the connecting sections 31 at both ends of the detachable member 30 and the connecting sections 23 at both ends of the support connecting portion 22 are screwed with each other to form an integral structure of the automobile steering wheel 20.

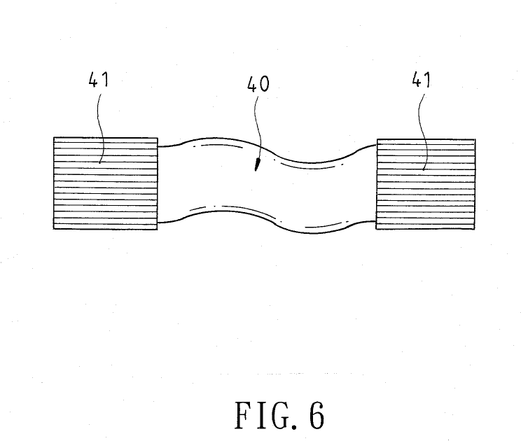

In FIG. 6, the detachable member 40 is a circular rod substantially S-shaped, and the detachable member 40 includes a connecting section 41 disposed separately at both ends of the detachable member 40.

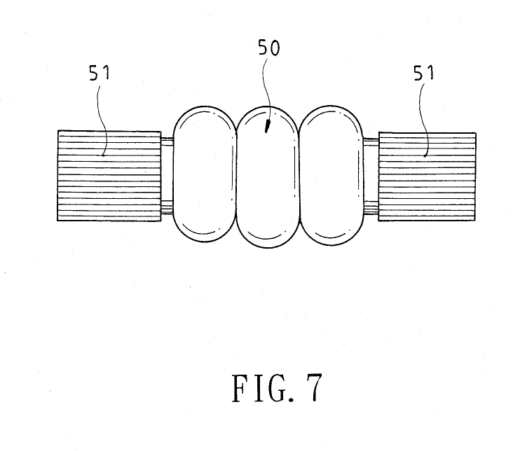

In FIG. 7, the detachable member 50 is a member comprised of a plurality of convex rings, and the detachable member 50 includes a connecting section 51 disposed separately at both ends of the detachable member 50.

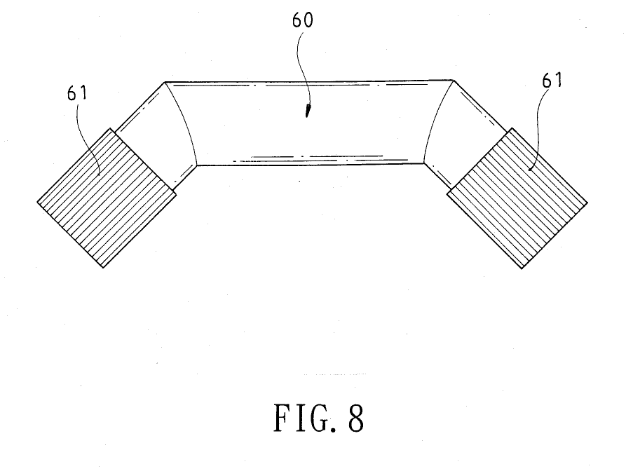

In FIG. 8, the detachable member 60 is a circular rod bent at different section with an angle, and the detachable member 60 includes a connecting section 61 disposed separately at both ends of the detachable member 60.

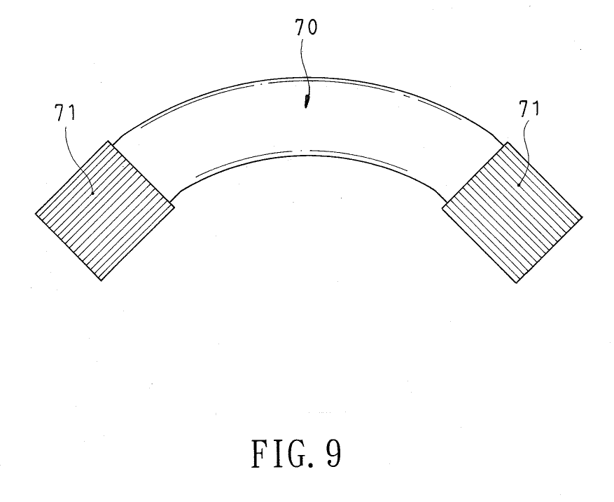

In FIG. 9, the detachable member 70 is a circular rod in a curved form, and the detachable member 70 includes a connecting section 71 disposed separately at both ends of the detachable member 70.

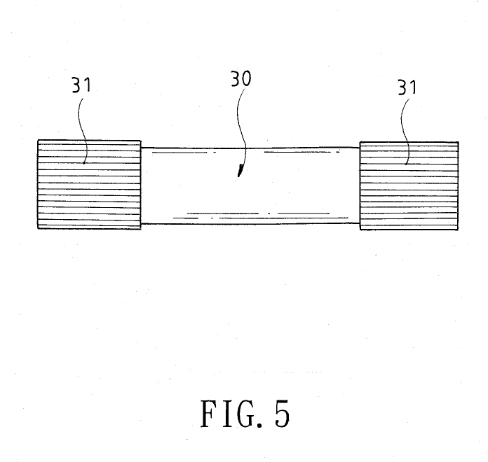

In the automobile steering wheel of the present invention, the connecting sections at both ends of the support connecting portion and the connecting sections at both ends of the detachable member are fixed to each other. The detachable member 30, 40, 50, 60, 70 can have various different shapes as shown in FIGS. 5 to 9 to provide a better flexibility to meet user requirements and reduce manufacturing cost and consumer's burden, while enhancing the practical use and value of the steering wheel.

In the preferred embodiments of the present invention, the connecting sections at both ends of the support connecting portion and the detachable members at both ends of the connecting section are fixed to each other. In the preferred embodiments as shown in FIGS. 3 to 5, a structure using a thread for the fixation is provided for illustrating the present invention, but the invention can also uses a latch, a hook, or any other fixing method to achieve the same effect. In addition, the size of the steering wheel and the material used for making the steering wheel can be changed as needed.

While the invention has been described by means of specific embodiments, numerous modifications and variations could be made thereto by those skilled in the art without departing from the scope and spirit of the invention set forth in the claims.

In summation of the above description, the present invention herein enhances the performance than the conventional structure and further complies with the patent application requirements and is submitted to the Patent and Trademark Office for review and granting of the commensurate patent rights.

What is claimed is:

1. An automobile steering wheel, comprising an extension support, a plurality of support connecting portions and a detachable member, characterized in that the extension support is integrally formed by a metal material, and a plurality of support connecting portions are disposed at an external periphery of the extension support, and a connecting section is disposed separately at both ends of the support connecting portion, and an assembly positioning hole is formed at the center of the extension support, and a connection section is disposed separately at both ends of at least one detachable member, thereby the connecting sections at both ends of the detachable member and the connecting sections at both ends of the support connecting portion are fixed to each other to constitute an integral structure.
